(19) United States
(12) Patent Application Publication
(10) Pub. No.: US 2025/0196153 A1
(43) Pub. Date: Jun. 19, 2025

(54) FINE GRINDING APPARATUS AND METHOD FOR GRINDING GRANULAR MATERIAL

(71) Applicant: MOVIATOR OY, Vaajakoski (FI)

(72) Inventor: Pertti HÄNNINEN, Vaajakoski (FI)

(73) Assignee: MOVIATOR OY, Vaajakoski (FI)

(21) Appl. No.: 18/849,714

(22) PCT Filed: Mar. 21, 2023
(86) PCT No.: PCT/FI2023/050160

§ 371 Date: Sep. 23, 2024

(30) Foreign Application Priority Data
Mar. 24, 2022 (FI) 20225256

(51) Int. Cl. B02C 15/00; B02C 21/00

(52) U.S. Cl. CPC B02C 15/007; B02C 15/003; B02C 21/00

(57) ABSTRACT

The object of the is A fine grinding apparatus and a method for grinding granular material includes a grinding plate rotating on the horizontal plane around a vertical rotation axis, onto the top surface of which grinding plate the material to be ground can be fed, and on the top surface (of which grinding plate is a plurality of grinding discs, which rotate from the effect of the rotating motion of the grinding plate and compress the material to be ground against the grinding plate. The apparatus has one or more refiner elements pressing against the top surface of the grinding plate and rotatable around their vertical center axes, by means of which elements the material to be ground is kneaded on the top surface of the grinding plate.

The object of the present invention is a fine grinding apparatus as presented in the preamble of claim 1 and a method as presented in the preamble of claim 10 for grinding granular material.

The fine grinding apparatus and method according to the invention, hereinafter more concisely solution, is well suited e.g. for grinding the slag produced in conjunction with crushed steel slag or other metal manufacturing into a very small-sized fraction.

One fine grinding apparatus implementing the solution according to the invention is an improved plane grinder comprising an essentially planar grinding plate rotating on the horizontal plane, onto the top surface of which the material to be ground can be fed, and wherein on the top surface of the grinding plate is a plurality of grinding discs, which rotate from the effect of the rotating motion of the grinding plate and press the material to be ground against the top surface of the grinding plate by means of the compressive forces of the compression means acting on the grinding discs. The aforementioned fine grinding apparatus further comprises disc-like refiner elements to be pressed against the grinding plate, which elements are adapted to press and grind the material to be ground coming between the refiner elements and the top surface of the grinding plate into extremely fine-grained material for further processing.

Grinder devices known per se in the art, or more concisely mills, applicable to grinding steel slag are disclosed e.g. in Finnish utility model no. FI12742 and Finnish patent no. FI128329. Tests and use of the mills have demonstrated that the crushed material is of exactly the right quality for what is desired for the mill. These mills, however, do not have a grinding plate rotating on the horizontal plane around a vertical axis according to the present invention nor grinding discs rotating on its surface. One plane grinder provided with grinding discs is disclosed in the Finnish utility model no. FI13080 of the same applicant, but this solution does not comprise the aforementioned disc-like refiner elements that enable a more fine-grained grinding result than the aforementioned utility model.

One grinder device provided with grinding discs or rolls rotating along with a grinding plate rotating on the horizontal plane is disclosed in Chinese patent specification no. CN106861824 A. The grinder device comprises a grinding plate rotating on the horizontal plane, on the outer edge of which is a separate inclined grinder groove, in which the individual grinding discs are disposed to rotate from the force of the rotating motion of the grinding plate. Each grinding disc is on its own rotating shaft, which is in an oblique attitude, i.e. at an angle with respect to the horizontal plane of the top surface of the grinding plate. In addition, a hydraulic cylinder is fastened to each angled shaft of a grinding disc, with which cylinder the pressing of the grinding disc on the grinding plate and the angle of the shaft with respect to the horizontal plane can be adjusted. The structure of the CN specification differs substantially from the structure according to the invention, in which the rotating shaft of the grinding discs can revolve around the plane of rotation that is on the vertical plane of the grinding disc, i.e. can simultaneously revolve the plane of rotation of the grinding discs around a vertical axis of rotation. This cannot be done in the solution according to the CN specification. The solution according to the CN specification also does not comprise the aforementioned disc-like refiner elements.

The plane of rotation in this context refers to the plane that is perpendicular in relation to the axis of rotation of the grinding disc and that runs in the direction of the plane of the sides of the grinding disc via the center point of the grinding disc. In practice, this type of plane passes through the center point of the width of the grinding disc. The plane of rotation can also be referred to as the rotation plane. When the rotating shaft of a grinding disc is on the horizontal plane, the plane of rotation of the grinding disc is on the vertical plane.

Also US patent specification no. U.S. Pat. No. 3,951,347 discloses a grinder device for pulverizing hard-to-pulverize material. According to the patent specification, the device comprises a customary rotatable grinding plate and a plurality of rotatable grinding discs or rolls in a groove on the surface of the plate. Each disc package has two grinding discs and they are connected to each other with a common horizontal shaft, as also in the solution according to the invention. However, there is no mention in the patent specification that the grinding discs would revolve around their plane of rotation, nor are such structures visible in the drawings of the patent specification. The solution according to the US specification also does not comprise the aforementioned disc-like refiner elements.

With the solutions according to prior art it is not possible to achieve an end result of sufficient quality for all purposes. For example, with the solutions according to prior art ground steel slag cannot necessarily be used with good success as an additive to, or substitute for, cement powder in the manufacture of concrete.

The aim of the present invention is to eliminate the aforementioned drawbacks and to provide a simple and inexpensive fine grinding apparatus and method e.g. for bringing steel slag to such a grinding fineness and quality that it can be used, inter alia, as a substitute for cement powder, to replace cement powder either partly or completely. Another aim of the invention is to further develop a plane grinder and to improve its efficacy and result. The fine grinding apparatus according to the invention is characterized by what is disclosed in the characterization part of claim 1. Correspondingly, the method according to the invention is characterized by what is disclosed in the characterization part of claim 10. Other embodiments of the invention are characterized by what is disclosed in the other claims.

For realizing the aim of the invention, the fine grinding apparatus according to the invention for grinding granular material comprises a grinding plate rotating on the horizontal plane around a vertical axis of rotation, onto the top surface of which the material to be ground can be fed, and on the top surface of which grinding plate is a plurality of grinding discs, which rotate from the effect of the rotating motion of the grinding plate and compress the material to be ground against the grinding plate.

Preferably the apparatus comprises one or more refiner elements pressing against the top surface of the grinding plate.

The method according to the invention comprises a grinding plate rotating on the horizontal plane around a vertical axis of rotation, onto the top surface of which the material to be ground is fed, and on the top surface of which grinding plate is a plurality of grinding discs, which rotate from the effect of the rotating motion of the grinding plate and compress the material to be ground against the grinding plate. Preferably, in addition to grinding with grinding discs, the material to be ground is kneaded against the top surface of the grinding plate with one or more refiner elements rotatable around a vertical axis.

Preferably the plane of rotation of the bottom surface, i.e. the contact surface, of the refiner element is kept in the refining phase essentially parallel with the plane of rotation of the top surface of the grinding plate and at the same time the bottom surface of the refiner element is pressed against the top surface of the grinding plate by means of a vibration motion that produces both a vertical and a horizontal movement in the refiner element.

One great advantage of the solution according to the invention is a simple, operationally reliable and inexpensive grinder apparatus e.g. for grinding steel slag. Another advantage is also an improvement in the quality of the grinding result. With the solution according to the invention the properties of ground steel slag can be improved and brought to such a fineness and quality that it can be used, inter alia, as a substitute for cement.

The apparatus according to the invention, preferably a fine grinding apparatus, is intended for grinding residual slag produced from a steel mill, whereby steel residues are separated from residual lime. The residual lime can be ground with the fine grinder according to the invention to be so dust-like that the lime is suited to the steel industry as a substitute, either partly or fully, for cement powder. The residual slag is subjected to kneading treatment between the top surface of the grinding plate and the grinding discs and also the refiner elements, in which case heat that assists the grinding is also produced. If the ground lime is not ground to be sufficiently fine it is conducted back into the grinding cycle again until the grain size of the residual lime is between 10-50 μm, which is suitable for the cement industry as a substitute for cement.

One advantage also is that refiner elements blocked over time by ground material, especially damp material, can be effectively cleaned e.g. with a pressure shock of positive pressure through the rotator shaft of the refiner element. This is possible because air can be both blown and sucked through the hollow rotator shaft. Another advantage as a consequence of this is that damper material can be processed with the apparatus than could normally be processed.

Another advantage is that because the disc-like refiner elements are as far from the center point of rotation of the grinding plate as the grinding discs, the disc-like refiner elements in turn keep the top surface of the grinding plate flat, in which top surface the grinding discs tend to cause a slight groove formation over time.

In the following, the invention will be described in more detail by the aid of some preferred embodiments with reference to the simplified and diagrammatic drawings attached, wherein

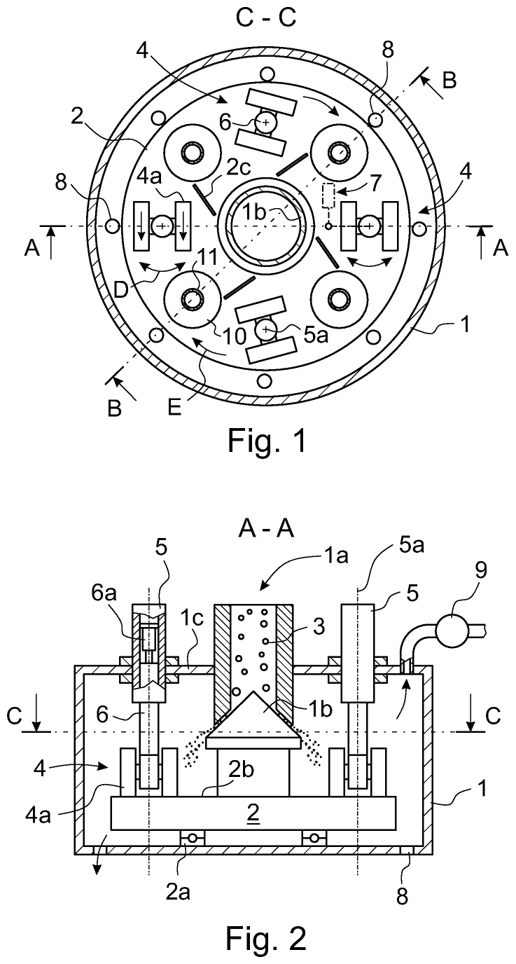

FIG. 1 presents a simplified top view of one fine grinding apparatus according to the invention, when sectioned along the line C-C of FIG. 2, and also of the grinding discs in their different revolving positions,

FIG. 2 presents a simplified side view of the fine grinding apparatus according to FIG. 1, when sectioned along the line A-A of FIG. 1,

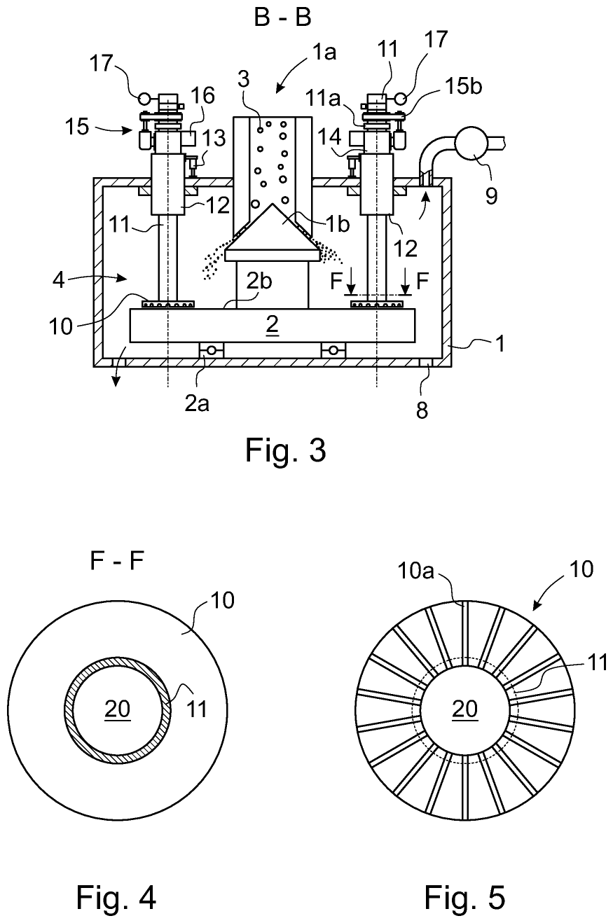

FIG. 3 presents a simplified side view of the fine grinding apparatus according to FIG. 1, when sectioned along the line B-B of FIG. 1,

FIG. 4 presents a top view of one refiner element to be used in the solution according to the invention, when sectioned along the line F-F of FIG. 3,

FIG. 5 presents a refiner element according to FIG. 4 when viewed from below, and

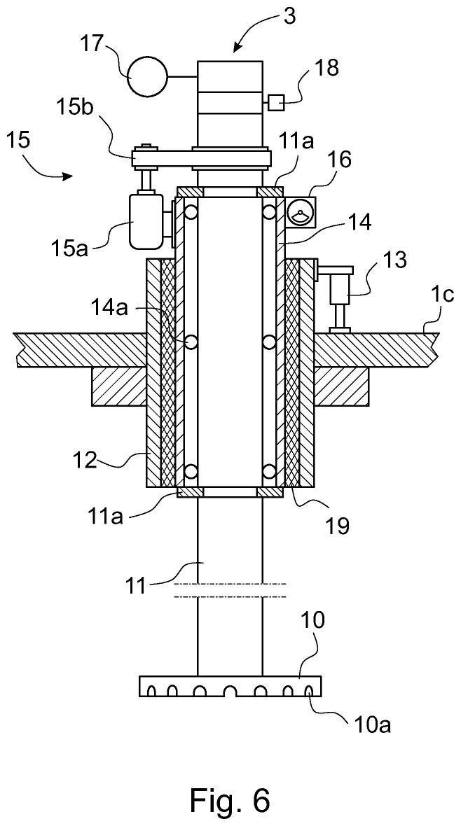

FIG. 6 presents a simplified side view of one refiner arrangement of a fine grinding apparatus according to the invention, when partially sectioned and also truncated in the vertical direction.

FIGS. 1-3 present one simplified and partially cross-sectioned fine grinding apparatus to be used in the solution according to the invention. In FIG. 1 the fine grinding apparatus is presented as viewed from above when sectioned along the line C-C of FIG. 2, in FIG. 2 the fine grinding apparatus is presented as viewed from the side when sectioned along the line A-A of FIG. 1, and in FIG. 3 the fine grinding apparatus is presented as viewed from the side when sectioned along the line B-B of FIG. 1.

For the sake of clarity, the structures of the refiner arrangement are not visible in FIG. 2 and, correspondingly, the grinding disc structures are not visible in FIG. 3.

The apparatus according to the invention, i.e. preferably a fine grinding apparatus, comprises a casing-type frame part 1 comprising a cover 1c, a base and the wall sections connecting them, which parts enclose the grinding space inside them. Inside the frame part 1 is an essentially planar grinding plate 2 mounted on one or more support bearings 2a and rotating on the horizontal plane around its vertical axis of rotation in the direction of the arrow E, onto the top surface 2b of which grinding plate the material 3 to be ground can be fed via the input aperture 1a.

Below the input aperture 1a, at the center point of the grinding plate 2 is conical grinder 1b, from where there is passage to the top surface 2b of the grinding plate 2 for the material 3 to be ground. Preferably the conical grinder 1b comprises a cone narrowing upwards rotating along with the grinding plate 2 and a non-rotating counter-cone opening downwards, between which cones is a narrow gap through which the material to be ground is able to drop onto the top surface 2b of the grinding plate 2.

The material 3 to be ground is e.g. steel slag crushed to become granular material and pre-screened, which material contains residual lime. In such a case, the maximum grain size of the infeed, i.e. the material 3 to be ground, can advantageously be approx. 4 mm.

On the top surface 2b of the grinding plate 2 is a plurality of grinding disc units 4 with their grinding discs 4a, which rotate around their essentially horizontal axis of rotation from the effect of the rotating motion of the grinding plate 2. Each grinding disc unit 4 is fitted by means of its vertical drive shaft 6 to its own support 5, means preferably to a hollow vertical shaft, which is fixed immovably to the cover 1c of the frame part 1. Each drive shaft 6 is fastened at its bottom end to its grinding disc unit 4.

In addition, the apparatus comprises a pressing mechanism 6a for each grinding disc unit 4. The pressing mechanism 6a can preferably be inside a hollow, tubular support means 5 and arranged to press the grinding discs 4a against the grinding plate 2. The pressing mechanism 6a can comprise e.g. one or more power means, such as a hydraulic cylinder, which is adapted to press the vertical drive shaft 6 in the vertical direction towards the grinding plate 2. With their outer rim the grinding discs 4a press the material 3 to be ground against the grinding plate 2 from the effect of the compressive forces acting on the grinding discs 4a.

By revolving the drive shaft 6 around its vertical center axis, the grinding disc unit 4 simultaneously revolves around its vertical center axis, i.e. around its vertical axis of rotation 5a. Preferably the vertical center axis of the support means 5, the vertical center axis of the drive shaft 6, and the vertical axis of rotation 5a of the grinding disc unit 4 are all on the same straight vertical line. When the grinding disc unit 4 revolves around its vertical axis of rotation 5a, the plane of rotation of each grinding disc 4a simultaneously pivots. This function can also be called revolving of the plane of rotation around the axis of rotation 5a.

In this case the friction between the top surface 2b of the grinding plate 2 and the grinding discs 4a increases and a grinding friction force is produced in the material to be ground between the grinding discs 4a and the surface 2b of the grinding plate 2, which force improves the grinding result. Preferably the compressive force of the pressing mechanism 6a acts on the grinding disc unit 4 and grinding discs 4a via the drive shaft 6.

The revolving of the drive shafts 6 around their center axes, e.g. in the manner presented by the arrow D in either rotation direction whatsoever, is realized with the revolver mechanism 7 of the solution, which preferably comprises e.g. a force cylinder and an articulation mechanism suited to the purpose. The revolver mechanism 7, which is presented in conjunction with only one grinding disc unit 4 and diagrammatically with a dot-and-dash line in FIG. 1, can be disposed e.g. on the cover 1c of the frame part 1 or in some other suitable location on the frame part 1. The revolver mechanism 7 can be e.g. inside the frame part 1 fastened to the roof or side wall of the frame part.

The solution according to the invention also comprises a plurality of refiner elements 10 of the refiner arrangement of the fine grinding apparatus, which elements are disposed inside the frame part 1, immediately above the top surface 2b of the grinding plate 2 and are adapted to exert a compressing and kneading effect between their bottom surfaces and the top surface 2b of the grinding plate. In this case, the bottom surface of the refiner element 10 acts as a contact surface between the refiner element 10 and the top surface 2b of the grinding plate 2. Preferably the refiner elements 10 are radially essentially as far from the center point of the grinding plate 2 as the grinding discs 4a and are disposed at regular intervals in the spaces remaining between the grinding disc units 4. In this case the center of rotation of the refiner elements 10 and the center of rotation of the grinding disc units 4 are of an equal distance from the center point of the grinding plate 2.

Each refiner element 10 is attached to the bottom end of its essentially vertical tubular rotator shaft 11, which rotator shaft 11 is disposed at its top end through the cover 1c of the fine grinding apparatus and is preferably supported by the same cover 1c. Preferably the rotator shaft 11 is hollow.

Above the top surface 2b of the grinding plate 2 is a plurality of guide means 2c, such as guide strips, sweeps or guide brushes, which are arranged to guide the material falling from the conical grinder 1b and moving along with the grinding plate 2 on the top surface 2b of the grinding plate 2, and also ground by the grinding discs 4a, towards the outer edge of the grinding plate 2 and at the same time at least to beneath the refiner elements 10. The guide means 2c can be adapted to guide the material also to below the grinding discs 4a. Preferably the guide means 2c are fixed in a stationary position and do not rotate with the grinding plate 2. They can, however, have their own actuators, with which the guide means 2c can be moved in small reciprocating motions. The bottom surface of the guide means 2c are near the top surface 2b of the grinding plate 2, or in contact with and dragging on the top surface 2b. For the sake of clarity the guide means 2c are not presented in other drawings than FIG. 1, and in that they are presented in a simplified manner without, inter alia, their fastening means and support means.

FIG. 4 presents a top view of one refiner element 10 in the section F-F according to FIG. 3, and FIG. 5 presents one refiner element 10 from below. The refiner element 10 can be e.g. a disc-like ring-shaped part, e.g. a round plate or disc, in the center of which is a hole 20 and the bottom surface of which is essentially flat apart from grooves 10a opening downwards on the bottom surface, which grooves preferably extend upwards from the bottom surface and radially from the inner diameter of the ring, i.e. from the hole 20, to the outer diameter. Preferably the plane of the bottom surface of the refiner element 10 is in the same direction as the plane of the top surface 2b of the grinding plate 2, i.e. the plane of rotation of the bottom surface of the refiner element 10 is parallel with the plane of rotation of the top surface 2b of the grinding plate 2. The refiner element 10 can also be described in such a way that the surface of the refiner element 10 contacting the top surface 2b of the grinding plate 2 is planar.

The grooves 10a can also form other patterns than being radially straight. The grooves can be e.g. ring-shaped, helical or spiral. Preferably, however, the grooves 10a extend from the hole 20 to the outer edge of the refiner element 10. The grooves 10a facilitate the removal of ground material from between the bottom surface of the refiner element 10 and the top surface 2b of the grinding plate 2. Owing, inter alia, to the direction of rotation of the refiner element 10, the helical and spiral grooves 10a can drive the material either towards the center part of the refiner element 10 or towards its outer edge. The material can be driven in the grooves 10a towards the center part when material processed to be fine is removed from the frame part 1 and towards the outer edge when material to be handled brought for grinding is fed into the frame part 1 via the rotator shaft 11.

FIG. 6 presents a simplified and diagrammatic view of the support structure and actuators of one refiner arrangement according to the invention, when magnified and partially sectioned. The hollow rotator shaft 11, which in FIG. 6 is not sectioned, is mounted on bearings 14a in a manner allowing it to rotate inside the vertical body pipe 14. The bearings 14a are e.g. conical roller bearings receiving axial forces, but they are drawn in a simplified manner in FIG. 6. Axially the body pipe 14 and bearings 14a can also be locked to the rotator shaft 11 e.g. by means of circlips 11a.

Correspondingly, the body pipe 14 is fastened at its outer surface via the flexible element 19 to the inner surface of the preferably tubular support element 12 surrounding it. The flexible element 19 can be a tubular vulcanized rubber layer that is attached to both the body pipe 14 and to the support element 12. Both the flexible element 19 and the support element 12 can extend through the cover 1c of the frame part 1 to inside the frame part, or they can also be completely above the cover 1c of the frame part 1. The support element 12 is supported on the cover 1c of the frame part 1 by means of an adjustable support means 13, with which means the distance of the support element 12 and at the same time of the body pipe 14 and also of the refiner element 10 from the top surface 2b of the grinding plate 2 can be adjusted.

The body pipe 14 moves along with the support element 12, by virtue of the flexible element 19, in the vertical direction in relation to the top surface 2b of the grinding plate 2, either away from the top surface or towards the top surface. The support means 13 can be e.g. a hydraulic cylinder, a transmission screw or some other e.g. mechanical actuator suited to the purpose. The compressive force of the bottom surface of the refiner element 10 against the top surface 2b of the grinding plate 2 can be adjusted by means of the support means 13 by changing the vertical distance of the bottom surface from the top surface 2b of the grinding plate 2. The structure of the refiner arrangement can also be such that the self-weight of the structural parts of the refiner arrangement is sufficient to produce the necessary compression effect of the refiner element 10 against the top surface 2b of the grinding plate 2.

The refiner arrangement also comprises a rotator unit 15 for the rotator shaft 11, the unit preferably comprising at least a rotator motor 15a and a transmission means 15b, such as a toothed belt transmission, for rotating the rotator shaft 11. The motor 15a can be fastened to the body pipe 14 to move axially along with the body pipe 14 and the toothed belt transmission 15b is adapted to rotate the rotator shaft 11 and at the same time the refiner element 10 fastened to the bottom end of the rotator shaft 11. The rotation speed and rotation direction of the rotator motor 15a and at the same time of the refiner element 10 is adjusted with a frequency converter belonging to the control system of the apparatus.

The refiner arrangement further comprises a vibrator device 16, which can be fastened to the body pipe 14. Preferably the vibrator device 16 is an eccentric device comprising actuators for bringing about a vibration motion in the body pipe 14, body pipe is adapted to transmit the vibration motion to the rotator shaft 11. The flexible element 19 enables the vibration motion. The vibrator device 16 makes the refiner element 10 move during grinding a short distance in both the horizontal direction and in the vertical direction in a vibratory manner. During kneading and grinding the vertical movability of the refiner element 10 permitted by the flexible means 19 is less than 4 mm, suitably less than 3 mm, and preferably less than 2 mm. The compression pressure of the vibration motion against the top surface 2b of the grinding plate 2 is adjusted by means of the support means 13 by changing the distance of the bottom surface of the refiner element 10 from the top surface 2b of the grinding plate 2 in such a way that the compression pressure is reduced by increasing the distance and raised by shortening the distance. The downward impact of the vibration motion also affects magnitude the of the compression pressure.

Preferably a pressure source 17 is further connected to the rotator shaft 11, by means of which pressure source an air flow is brought about inside the hollow rotator shaft 11, the air flow producing either negative pressure suction or positive pressure blowing, as necessary, between the grinding plate 2 and the refiner element 10. Positive pressure blowing can be used in the manner of a pressure shock, e.g. for opening blockages caused by damp material from the grooves 10a of the refiner elements 10 and from elsewhere in the refiner system. Using the same pressure source 17, it is possible to switch between suction and blowing by means of the control valve 18. The pressure source 17 can advantageously be a low-pressure compressor or pump.

With the method according to the invention the material 3 to be ground is preferably fed via the input aperture 1a into the fine grinding apparatus, preferably to the center of the grinding plate 2. When the material 3 being fed in is e.g. blast furnace slag or steel slag, it is pre-crushed and pre-screened to be of suitably small grain size. The material 3 to be fed in can also be pre-ground. The maximum grain size of the input material 3 can be e.g. less than 8 mm, suitably less than 5 mm, and preferably less than 3 mm or even less than 2 mm. The material 3 is dropped from the input aperture 1a onto the conical grinder 1b at the center point of the grinding plate 2, where pre-grinding of the material is performed, after which the material to be ground is dropped onto the top surface 2b of the grinding plate 2. Preferably the conical grinder 1b comprises a cone narrowing upwards rotating along with the grinding plate 2 and a non-rotating counter-cone opening downwards, between which cones is a narrow gap through which the material to be ground is able to drop after pre-grinding onto the top surface 2b of the grinding plate 2, where the material is ground and kneaded to become finer by means of the grinding discs 4a and the refiner elements 10.

Pulverizing of the material can be made more efficient by revolving the vertical plane of rotation of the grinding discs 4a and additional pulverizing can be performed with the refiner arrangement belonging to the fine grinding apparatus for an even finer-grained fraction. Preferably kneading is performed essentially simultaneously with the grinding to be performed with the grinding discs 4a, because the refiner elements 10 are essentially the same distance from the center point of the rotating grinding plate 2 as the grinding discs 4a and are preferably situated on the same circumference alternately with the grinding discs 4a in such a way that after each grinding disc unit 4 is a refiner element 10 on the same circumference. Preferably the material to be ground is guided to below the refiner elements 10 with the guide means 2c that are above the grinding plate 2 and that extend to the top surface 2b of the grinding plate 2.

By means of the refiner elements 10, more detrimental constituents of different types can be separated out from the kneaded dust-like material than from material processed only with grinding discs 4a. The material to be handled is conducted for kneading to between the refiner elements 10 of the refiner arrangement and the top surface of the grinding plate 2 and at the same time the refiner elements 10 are rotated around their vertical axes of rotation and also vibrated in the lateral direction and also against the grinding plate 2 in the vertical direction.

In this way the material to be ground containing e.g. crushed residual slag, said material containing residual lime, is conducted in the apparatus to kneading treatment between the top surface 2b of the grinding plate 2 and the grinding discs 4a as well as the refiner elements 10, in which case heat that assists the grinding is also produced. If the ground material, mostly lime, is not ground to be sufficiently fine, it is conducted back into the grinding cycle again until the grain size of the material, i.e. in practice residual lime, is between 10-50 μm, which is suitable for the cement industry as a substitute for cement.

The material ground and kneaded between the grinding plate 2 and the grinding discs 4a and refiner elements 10 forms fine dust-like material, which contains, inter alia, calcium oxide. Material treated to be extremely fine-grained is very light and easily rises as dust into the top part of the frame part 1, from where it can be removed via one or more discharge arrangements 9 connected to the cover 1c or top part of the frame part of the apparatus, by means of either suction or positive pressure inside the frame part 1. The ground and kneaded material removed from the apparatus is transferred by means of the discharge arrangement 9 into a suitable collection reservoir for further processing. For the sake of simplicity, this dust-like material is hereinafter also just called lime.

The ground and kneaded material can be removed from inside the frame part 1 also via the hollow rotator shafts 11 of the refiner arrangement. In such a case, each pressure source 17 is adjusted by means of its control device 18 to produce suction pulling the material upwards to inside the rotator shaft 11, with which suction the material is sucked through the grooves 10a of the refiner element 10 and through the rotator shaft 11 away from the inside of the frame part 1 and delivered onwards to a suitable collection reservoir for further processing.

The ground and kneaded dust-like material can be removed from inside the frame part 1 either via the discharge arrangement 9 or via the rotator shafts 11 or simultaneously via both.

The material 3 to be ground can be fed into the apparatus also through the hollow rotator shafts 11. In such a case the material 3 being fed in is sucked by the pressure source 17 from the feed reservoir or corresponding location and is conducted via the hollow rotator shaft 11 to directly below the refiner elements 10.

Coarser material, in which the ground steel slag contains pieces of steel and larger pieces of lime, is conducted to the edge of the grinding plate 2 and drops, or is dropped, from the edge of the grinding plate, e.g. via holes 8 in the base, onto a below, from where the material is conducted, if necessary via magnetic separation and screening, again into the grinding apparatus for regrinding.

It is obvious to the person skilled in the art that the invention is not limited solely to the examples described above, but that it may be varied within the scope of the claims presented below. Thus, for example, the fine grinding apparatus can differ in its structural solutions to what is presented above.

It is also obvious to the person skilled in the art that the suspension structure of the grinding disc units can be different to what is described above. In this case e.g. the pressing of the grinding discs against the surface of the grinding plate could have been realized with other solutions than with a power cylinder concurrent with the direction of the vertical axis of the support means. The grinding discs can be pressed against the surface of the grinding plate by some suitable power means, e.g. from the side of the grinding disc unit.

It is also obvious to the person skilled in the art that the suspension of a grinding disc unit can be realized otherwise than with one drive shaft rotatable around its center axis. What is essential is that the structure of the plane grinder comprises means for turning the plane of rotation of the grinding discs to different angles with respect to the line between the position of the grinding discs and the center point of the grinding plate.

It is further obvious to the person skilled in the art that there can be different ratios of grinding disc units to refiner elements than what is presented above. Instead of the 4/4 ratio presented above, the ratio can be e.g. four grinding disc units and two refiner elements, i.e. 4/2, or any one of the following: 6/2, 3/2, 3/3, 2/2, 2/3, 2/4 or 2/6.

1. A fine grinding apparatus for grinding granular material, the apparatus comprising a grinding plate rotating on the horizontal plane around a vertical rotation axis, onto the top surface (of which the material to be ground can be fed, and on the top surface of which grinding plate is a plurality of grinding discs, which rotate from the effect of the rotating motion of the grinding plate and compress the material to be ground against the grinding plate, wherein the apparatus comprises one or more refiner elements pressing against the top surface of the grinding plate.

2. Fine grinding apparatus according to claim 1, wherein the apparatus comprises a rotator unit with motor for rotating the refiner element around the vertical axis.

3. Fine grinding apparatus according to claim 1, wherein the apparatus comprises one or more vertical rotator shafts, onto the bottom end of which is fastened a refiner element to rotate along with the rotator shaft in such a way that the plane of rotation of the bottom surface of the refiner element is parallel with the plane of rotation of the top surface of the grinding plate.

4. Fine grinding apparatus according to claim 1, wherein the apparatus comprises an adjustable support means for adjusting the distance of the refiner element with respect to the top surface of the grinding plate.

5. Fine grinding apparatus according to claim 1, wherein the rotator shaft is mounted on bearings in a manner allowing rotation inside a body pipe (14), which body pipe is suspended on the cover of the frame part of the apparatus by means of a flexible element.

6. Fine grinding apparatus according to claim 5, wherein the apparatus comprises a vibrator device comprising actuators for bringing about a vibration motion in the body pipe, which body pipe is adapted to transmit the vibration motion to the rotator shaft enabled by the flexible element.

7. Fine grinding apparatus according to claim 1, wherein the refiner element is a disc-like element, in the center of which is a hole in connection with the hollow inner part of the rotator shaft and on the bottom surface of which element are grooves opening downwards, the grooves extending from the hole to the outer edge of the refiner element.

8. Fine grinding apparatus according to claim 1, wherein a pressure source is connected to the rotator shaft of the refiner element for bringing about an air flow inside the hollow rotator shaft and to produce, if necessary, either negative pressure suction or positive pressure blowing between the grinding plate and the refiner element.

9. Fine grinding apparatus according to claim 8, wherein the apparatus comprises a control valve for controlling and changing the direction of the air flow produced by the pressure source and to produce either negative pressure suction or positive pressure blowing.

10. A method for grinding granular material in an apparatus that comprises a grinding plate rotating on the horizontal plane around a vertical axis of rotation, onto the top surface of which the material to be ground is fed, and on the top surface of which grinding plate is a plurality of grinding discs, which rotate from the effect of the rotating motion of the grinding plate and compress the material to be ground against the grinding plate, wherein in addition to grinding with the grinding discs, the material to be ground is kneaded against the top surface of the grinding plate with one or more refiner elements rotatable around a vertical axis.

11. Method according to claim 10, wherein in the kneading phase the plane of rotation of the bottom surface of the refiner element is kept essentially parallel with the plane of rotation of the top surface of the grinding plate.

12. Method according to claim 10, wherein during kneading the bottom surface of the refiner element is pressed against the top surface of the grinding plate.

13. Method according to claim 12, wherein in the kneading phase the bottom surface of the refiner element is pressed against the top surface of the grinding plate by means of the vibration motion, with which motion both vertical and horizontal movement is produced in the refiner element.

14. Method according to claim 1, wherein through the hollow rotator shaft of the refiner element is conducted an air flow directed at the grinding plate for conveying the material to be ground into the interior of the frame part of the apparatus and/or an air flow directed away from the grinding plate for conveying the ground material out from the interior of the frame part.

15. Method according to claim 1, wherein through the hollow rotator shaft of the refiner element is conducted a pressure shock directed at the grinding plate, for cleaning the hollow internal space of the rotator shaft and/or the grooves of the bottom surface of the refiner elements.
